(19) United States
(12) Patent Application Publication
(10) Pub. No.: US 2011/0246521 A1
(43) Pub. Date: Oct. 6, 2011

(54) SYSTEM AND METHOD FOR DISCOVERING IMAGE QUALITY INFORMATION RELATED TO DIAGNOSTIC IMAGING PERFORMANCE

(76) Inventors: Hui Luo, Pittsford, NY (US); Jacquelyn S. Whaley, Rochester, NY (US); David H. Foos, Webster, NY (US)

(21) Appl. No.: 13/104,266

(22) Filed: May 10, 2011

Related U.S. Application Data
(63) Continuation-in-part of application No. 12/190,613, filed on Aug. 13, 2008.
Application No. 12/190,613 is a continuation-in-part of application No. 11/834,304, filed on Aug. 6, 2007, now Pat. No. 7,899,229.
Application No. 11/834,304 is a continuation-in-part of application No. 12/486,230, filed on Jun. 17, 2009.
Application No. 12/486,230 is a continuation-in-part of application No. 11/834,222, filed on Aug. 6, 2007, now Pat. No. 7,912,263.
Application No. 11/834,222 is a continuation-in-part of application No. 11/959,805, filed on Dec. 19, 2007, now Pat. No. 7,995,828.

(51) Int. Cl. G06F 17/30

(52) U.S. Cl. 707/776; 707/E17.014

(57) ABSTRACT

A system for discovering information related to diagnostic imaging performance at a medical imaging site. The system includes at least one database of stored digital diagnostic images; and a user instruction interface for obtaining an operator request for information related to image quality of the stored digital diagnostic images. A data processor is in communication with the at least one database, the data processor being programmed with instructions to use only information found within the stored digital diagnostic images themselves. A data mining engine is in communication with the data processor, the data mining engine being programmed with instructions to use only information found within the retrieved digital diagnostic images themselves.

### CROSS REFERENCE TO RELATED APPLICATIONS

This application is a Continuation-in-Part of the following copending, commonly assigned, U.S. patent applications, the entire disclosures of which are incorporated by reference into this application:

(a) Ser. No. 12/190,613 filed Aug. 13, 2008 by Luo et al, entitled SYSTEM AND METHOD FOR DISCOVERING INFORMATION IN MEDICAL IMAGE DATABASE; and

(b) Ser. No. 11/834,304 filed on Aug. 6, 2007 by Luo et al, entitled METHOD FOR DETECTING ANATOMICAL BLUR IN DIAGNOSTIC IMAGES, now U.S. Pat. No. 7,899,229;

(c) Ser. No. 11/959,805 filed Dec. 19, 2007 by Wang et al, entitled SPECKLE REPORTING IN DIGITAL RADIOGRAPHIC IMAGING;

(d) Ser. No. 11/834,222 filed on Aug. 6, 2007 by Luo, entitled METHOD FOR DETECTING CLIPPED ANATOMY IN MEDICAL IMAGES, now U.S. Pat. No. 7,912,263; and

(e) Ser. No. 12/486,230 filed Jun. 17, 2009 by Wang et al, entitled AUTOMATED QUANTIFICATION OF DIGITAL RADIOGRAPHIC IMAGE QUALITY.

### FIELD OF THE INVENTION

The present invention relates generally to accessing image quality information captured within digital diagnostic images that have been stored in medical databases and in particular to using data mining techniques for obtaining image quality information stored in such databases.

### BACKGROUND OF THE INVENTION

Medical images play a role in medical diagnosis, therapy, surgical treatments and medical training, as well as in research. With the rapid advances in digital imaging modalities such as computed radiography (CR), digital radiography (DR), computed tomography (CT) and magnetic resonance imaging (MRI), for example, the number of digital medical images obtained each year by hospitals, clinics, and other health facilities has grown tremendously. Today, an average US hospital with 600 beds generates over one million images per year, and this number is expected to grow significantly in the near future. To efficiently manage these large image files and the associated diagnosis reports, Picture Archiving and Communications Systems (PACS), with images stored in Digital Imaging and Communications in Medicine (DICOM) format, and Radiology Information System (RIS) have been widely adopted by hospitals. Typically, digital images from the PACS and other information from the RIS are stored in large medical databases.

To date, the focus of attention in development of systems and utilities to meet the need for image management has largely been directed to archival storage of patient images and other pertinent patient records in such large medical databases. PACS, RIS, and other information storage systems used by hospitals store the collection of a patient's electronic data and images obtained and used for patient diagnosis. Once diagnosis is complete, the data stored is rarely retrieved for other purposes. Occasionally, an image may be retrieved from the database and viewed for historical interest or in order to track a particular disease pattern. Once an image is stored, however, there is generally little likelihood of its data being utilized for any other purpose.

In addition to its diagnostic data content, such large medical databases as a whole also contain other “hidden” information that, although not directly associated with diagnosis for a particular patient, may have value related to overall health-care quality and performance of the hospital or other medical imaging site or facility. The present inventors have found that this other, image quality information may be found within the digital diagnostic images and may be of value to hospital management, medical education and staff training, and research. Effective use of this image quality information may provide significant benefits, such as improving the efficiency of the hospital facility and enhancing the quality of health-care delivery. In conventional practice, however, no attempt is made to systematically seek out such image quality information from within the digital diagnostic image stored in the vast storage banks of patient image data that is archived by hospitals and other health facilities.

Of particular interest to radiology departments, for example, is image quality. In day-to-day digital radiographic acquisition, technologists perform some level of visual quality assurance (QA) on captured radiographic images. On a viewing console, each image is evaluated visually in order to check that it is free from defects that might impact diagnostic interpretation. Once an image is determined to be visually acceptable, it is released to a PACS for diagnostic interpretation by a radiologist. Images that, upon visual inspection, are found to have defects, such as clipped anatomy, over- or under-exposure, motion blur, or other defect, are generally rejected and retaken. In many environments, technologists perform this visual review process manually. Their ability to detect visible defects and exercise proper judgement can be affected by factors such as difficulty in viewing images at the proper resolution and under the best possible conditions, demanding workloads, and varying levels of training and experience. One or more of these factors can lead to defect oversight, so that images having marginal diagnostic quality at best may be stored in the PACS for use by the radiologist, without any short- or long-term correction taken. Diagnosis often suffers accordingly. Retaking the radiographic image, although it may be best for diagnostic accuracy, is highly undesirable for the patient and for efficient administration for a number of reasons. This activity requires rescheduling complications, cost, and delays, and introduces other administrative problems. As a result, some compromises can be made related to image quality, which can include accepting visually inspected images of disappointing quality in order to avoid huge disruptions in workflow, for example.

Administrators and management personnel recognize the general types of problems that impact the effectiveness and efficiency of their imaging facility. Without extensive effort, however, administrators and management personnel find it very difficult to uncover specific root causes of imaging problems that result in poor image quality and the need for retakes. Some types of problems, for example, can be alleviated by proper training of technologists if individual weaknesses can be more closely identified. Other problems can be addressed more appropriately by changes of practice in the imaging department. Still other types of chronic imaging problems are not skill- or setup-dependent, but may be more closely related to condition or age of equipment or to imaging conditions in general, some of which difficulties may have straightforward solutions. Discovering these types of root causes, given the huge mass of data that is available, is a daunting task for effective imaging facility administration.

Data mining techniques have been applied to the problems of patient diagnosis, for extracting patient data from multiple storage systems, as evidenced, for example, in U.S. Patent Application No. 2006/0265253 entitled “Patient Data Mining Improvements” by Rao et al. Solutions such as that proposed in the Rao et al. '5253 disclosure form a structured Computerized Patient Record (CRD) or similar data structure by collecting a composite set of information about an individual patient from two or more databases, such as billing and insurance databases, image storage repositories, and physician databases. A number of similar solutions have been proposed for mining the PACS database for individual patient data. For example, Stewart et. al, (“Computed radiography dose data mining and surveillance as an ongoing quality assurance improvement process”, American Journal of Roentgenology., Jul. 1, 2007; 189(1): 7-11), shows that mining PACS image data can be useful in reducing patient radiation dose and inter-examination dose variance. Anticipated benefits from such solutions include improved patient diagnosis with better access to all of the available patient records, reduced likelihood of duplication in imaging or treatment of patients, and improved overall efficiency in patient handling and billing. While such data mining techniques may be useful for obtaining comprehensive patient treatment data that is, of necessity, stored in various related systems, however, this diagnostic information relates only to each single patient, rather than to the performance of the imaging facility overall.

A method and apparatus for automated quality assurance in medical imaging are disclosed in U.S. Patent Application Publication 2006/027415 of Bruce Reiner. Quality related information is compiled for numerous patients by generation of a quality assurance database that is prepared from other data bases and used to track and report quality assurance scores for various groups, including patients, technologists and radiologists. This application of Reiner does not describe a technique for searching within a database of digital images for patterns or relationships. Related technology is disclosed in U.S. Patent Application Publication 2009/0030731, also of Bruce Reiner.

Thus, although data mining methods have been employed for obtaining information from different systems to aid in diagnosis of the individual patient, attention has not been paid to the particular difficulties and potential advantages of applying data mining techniques to information found within the diagnostic images themselves to produce image quality information for improved health care administration, particularly for improving image quality at a hospital or other diagnostic imaging site.

### SUMMARY OF THE INVENTION

An object of the present invention is to address the shortfalls of existing data mining approaches for medical images and information and to advance the art of healthcare administration and delivery thereby.

Another object of the invention is to provide a system and method for discovering within an existing medical image database image quality information related to diagnostic imaging performance at a medical imaging site. More particularly, this object concerns techniques for filtering information found within digital diagnostic images stored in such databases to retrieve the most informative diagnostic images related to image quality defects and for building an image processing database from such informative images. Data mining techniques then can be applied to the image processing database to discover information related to image quality.

A first embodiment of the invention concerns a system for discovering information related to diagnostic imaging performance at a medical imaging site. The system includes at least one database of stored digital diagnostic images; and a user instruction interface for obtaining an operator request for information related to image quality of the stored digital diagnostic images. A data processor is in communication with the at least one database, the data processor being programmed with instructions to use only information found within the stored digital diagnostic images themselves: (a) for retrieving digital diagnostic images for one or more patients from the at least one database according to the operator request from the user instruction interface: (b) for analyzing the image quality of the retrieved digital diagnostic images as specified in the operator request; and (c) for providing at least output information about the image quality analysis to a data mining engine. A data mining engine is in communication with the data processor, the data mining engine being programmed with instructions to use only information found within the retrieved digital diagnostic images themselves: (d) for processing the output information that is obtained from the data processor; and (e) for providing information related to image quality and the diagnostic imaging performance at the medical imaging site, according to the output information.

In the first embodiment, the instructions for retrieving digital diagnostic images may specify one or more of patient medical condition, image capture system identifier, patient age, and type of diagnostic image. The provided information related to image quality may include information related to one or more of a clipped anatomy defect, motion blur, over-exposure, under-exposure, image speckle, missing marker defect and unacceptable contrast-to-noise value. The information provided by the data processor and the data mining engine may relate to probability of an imaging artifact in the one or more retrieved patient diagnostic images. The instructions for retrieving one or more patient diagnostic images may specify a particular imaging technologist or a particular imaging apparatus. The information provided by the data processor related to image quality may include information on the severity of a detected problem. The data processor may include one or more modules for analyzing the retrieved diagnostic images and outputting probability values to identify one or more of the group of imaging artifacts consisting of motion blur, over-exposure, under-exposure, clipped anatomy, missing marker, and image speckle. The information related to image quality from the data processor may include formation related to cumulative exposure and exposure-related trends during a period of time.

A second embodiment of the invention concerns a method for discovering information related to diagnostic imaging performance at a medical imaging site from a database of stored digital diagnostic images. The method includes using a computer to perform steps of: (a) obtaining user instructions for information related to image quality of the stored digital diagnostic images; (b) directing a query for the image quality information to a data processing engine; (c) using the data processing engine and only information found within the stored digital diagnostic images themselves, retrieving digital diagnostic images for one or more patients from the database according to the query; (d) analyzing the retrieved digital diagnostic images to provide an assessment of image quality thereof according to the query; (e) providing at least output information about the image quality assessment to a data mining engine; (f) using the data mining engine and only information found within the retrieved digital diagnostic images themselves, correlating the at least output information with one or more of a technician, an imaging apparatus, a patient condition, an image type, and a time interval; and (g) providing results of the correlating as output information related to image quality and the diagnostic imaging performance at the medical imaging site.

In the second embodiment, a step may be included for displaying the output information on a display monitor. The assessment of image quality may include information about one or more of the group of imaging artifacts consisting of motion blur, over-exposure, under-exposure, clipped anatomy, missing marker, and image speckle. The information provided by the data processing engine and the data mining engine may relate to probability of an imaging artifact in the one or more retrieved patient diagnostic images. The output information further may include warning information related to the assessment of image quality.

A third embodiment of the invention concerns a method for obtaining information related to performance of a diagnostic imaging facility. The method may include using a computer to perform steps of: (a) accessing a database of stored digital diagnostic images; (b) obtaining image quality criteria; (c) obtaining condition criteria that identify one or more of patient pathology, image capture apparatus, time interval, and technologist obtaining a digital diagnostic image; (d) using only information found within the stored digital diagnostic images themselves, retrieving one or more images for each of a plurality of patients from the database according to the condition criteria; (e) analyzing the one or more retrieved images according to the image quality criteria; and (f) reporting results of the analysis according to the image quality criteria as output information related to image quality and the diagnostic imaging performance at the diagnostic imaging facility.

In the third embodiment, the step of obtaining image quality criteria may include responding to instructions obtained from a user interface. The image quality criteria may include one or more imaging artifacts taken from the group consisting of motion blur, over-exposure, under-exposure, clipped anatomy, missing marker, and image speckle. The information provided by the retrieving and analyzing steps may relate to probability of an imaging artifact in the one or more retrieved patient diagnostic images. The step of reporting results further may include providing information on the severity of an image artifact.

It is a feature of the present invention that it employs data mining to obtain and assess image data for quality and performance information about the imaging facility itself and to obtain other non-image patient information.

An advantage provided by embodiments of the system of the present invention is that administrative information that spans multiple patient records, including patient images, can be obtained and analyzed for improving imaging performance.

These and other objects, features, and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

The foregoing and other objects, features, and advantages of the invention will be apparent from the following more particular description of embodiments of the invention, as illustrated in the accompanying drawings.

FIG. 1 illustrates a system architecture for an embodiment of the present invention.

FIG. 2 is a block diagram showing the format of a data source record.

FIG. 3 shows an example of the data processing engine used for image quality evaluation.

FIG. 4 is a logic flow diagram illustrating an automated method for detecting motion blur in an image.

FIG. 5 shows the extraction of ROIs in a chest radiographic image with a lateral projection.

FIG. 6 is a logic flow diagram for calibrating motion sensitive image features.

FIGS. 7A and 7B are graphs that show a Gaussian equation and profile and Difference of Gaussian equation and profile that can be used in calculating motion sensitive image features.

FIG. 8 shows another example of the data processing engine used for image diagnosis.

FIG. 9 shows types and uses for output of the query engine.

FIGS. 10A-10G show portions of a graphical user interface for entry of user instructions in one embodiment of the present invention.

FIG. 11 shows a plan view of an example report of cumulative exposure averages.

FIG. 12 shows a portion of an exemplary output report on technician performance.

FIG. 13 shows a portion of an exemplary output report on patient exposure conditions; and

FIG. 14 shows a portion of an exemplary output report on equipment performance.

### DETAILED DESCRIPTION OF THE INVENTION

The following is a detailed description of the preferred embodiments of the invention, reference being made to the drawings in which the same reference numerals identify the same elements of structure in each of the several figures.

In the context of the present disclosure, the term “engine” has the meaning generally understood in computer systems design, that is, indicating a hardware or software component, or interacting system of hardware and software components, capable of executing programmed instructions.

As noted above, digitally captured or digitized medical diagnostic images are generally stored in the Digital Imaging and Communications in Medicine (DICOM) format in the PACS database. The DICOM format provides a standard mechanism for handling, storing, printing and transmitting information related to such digital medical diagnostic images. The DICOM data structure relates not only to diagnostic image data, but also to non-image data that is acquired during image capture, such as identification of body part and projection view, information on patient radiation dose, and technologist identifier, as well as to other exposure-related parameters.

Unlike the various types of conventional data mining applications that extract information related to an individual patient, embodiments of the present invention address the need for obtaining information from the digital diagnostic images themselves of one or more patients stored in the PACS database and other medical databases, wherein the information obtained relates to the administration of health care, including the operation of health imaging facilities. Using the system and methods of the present invention, information from the digital diagnostic images themselves can be obtained from different medical image and other databases to support functions such as performance assessment, training and education, and administrative functions, and to track trends in imaging parameters for improving how the health care imaging facility operates and for improving the efficiency of its imaging operations. Obtaining this type of overall administrative function requires novel approaches to the data mining problem and provides potential benefits for administrative and training personnel directed toward improving overall health-care delivery.

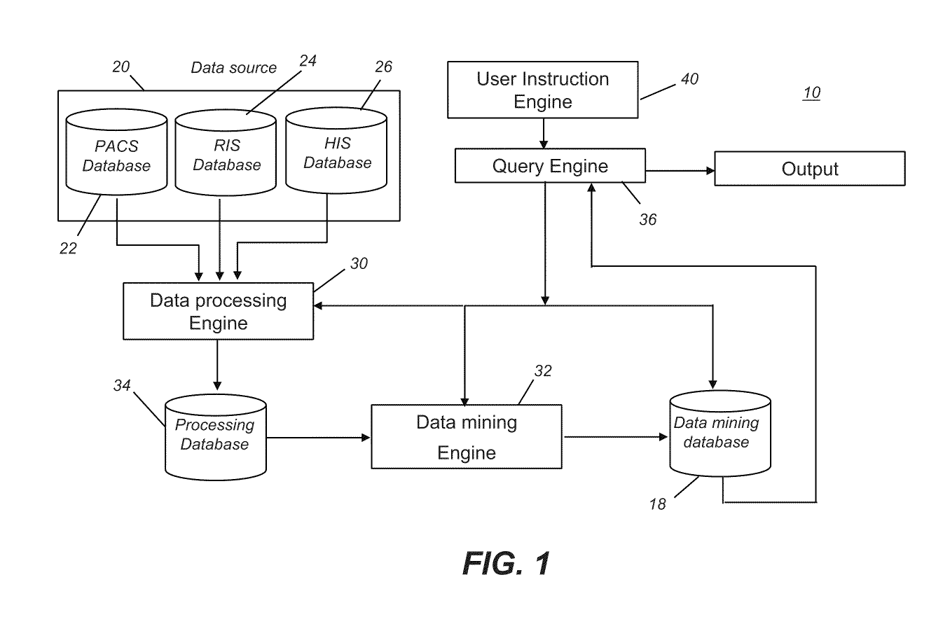

The block diagram of FIG. 1 illustrates a system architecture for a medical information system 10 in which various embodiments of the present invention may operate. Of particular interest relative to embodiments of the present invention are the following major components: (1) a data source 20; (2) a data processing engine 30; (3) a data mining engine 32; (4) a query engine 36; and (5) a user instruction engine 40. Each of these components is described in more detail subsequently.

### Data Source 20

A data source communicates with and provides access to data that is stored in different databases. In accordance with one embodiment of the present invention, the data source may contain some combination of Picture Archive And Communication System (PACS) databases 22, Radiology Information System (RIS) databases 24, and Hospital Information System (HIS) databases 26, as well as other data storage facilities. PACS database 22 stores and manages all digital diagnostic images acquired in the radiology department for image diagnosis. These images are stored in DICOM format, to facilitate image communication and display. RIS database 24 provides non-image information about radiology operation including patient registration, examination scheduling, diagnosis report, and other examination information. HIS database 26 is an integrated information system designed to manage the administrative, financial, and clinical aspects of a hospital. HIS database 26 provides detailed information related to the patient record, such as patient medical history, clinic diagnosis, and lab test data.

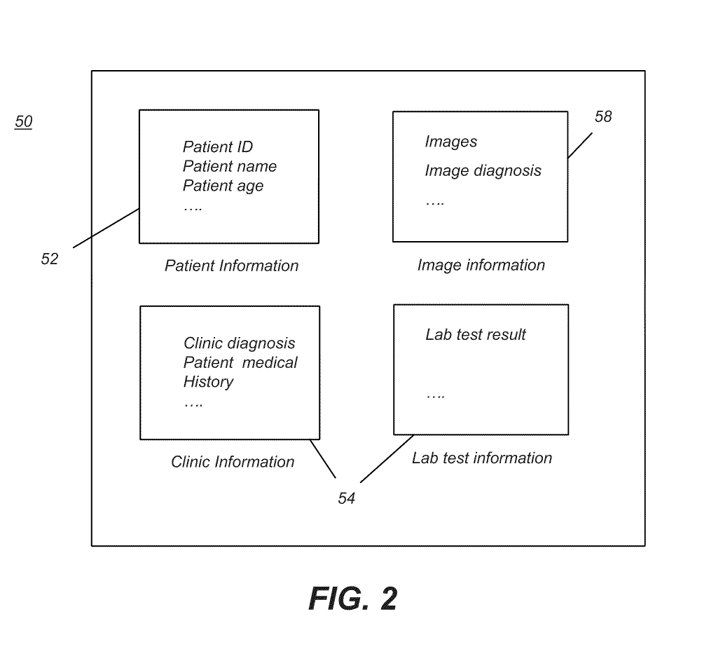

FIG. 2 shows an example format of one or more source records 50 provided by data source 20 in one embodiment. The data provided may include a patient identification field 52, one or more clinical test fields 54, a medical diagnosis field (not shown), and an image diagnosis field 58. According to an embodiment of the present invention, the databases in data source 20 may transmit source records on a fixed or periodic basis, such as one time per week, or once a month, or on a variable basis, for example, after a given amount of data is accumulated.

### Data Processing Engine 30

Data mining processes of the present invention apply image analysis logic to digital diagnostic images themselves that are stored in PACS database 22 or other database, extracting information from the digital diagnostic images themselves that is of interest for evaluating image quality trends and the imaging processing operations and practices used to obtain images at a facility. By comparison with conventional data mining functions that attempt to extract image and/or non-image information from the database that helps to diagnose an individual patient, the data mining functions of embodiments of the present invention can be considered as extracting information from the digital diagnostic images themselves that helps to “diagnose” the effectiveness of the diagnostic imaging facility itself. To do this, embodiments of the present invention apply one or more image analysis functions to multiple digital diagnostic images that are archived in the database, including images from different patients. The process and statistical data that is thus gathered then provides a basis of knowledge about how images have been obtained for many patients, wherein this knowledge is gained from analysis of the digital diagnostic images themselves.

To provide this function using the system of FIG. 1, data processing engine 30, according to programmed instructions, receives and processes digital diagnostic image data from data source 20 per instructions from query engine 36 and places the results into a processing database 34. The performance of the processing task is determined by user instructions, obtained by user instruction engine 40, that specify the information in which users are interested. Based on user interest, different processing methods are performed to meet different users' information queries. For example, supervisory and administrative staff in the radiology department may wish to correlate the image quality of images in the imaging department to the technologist identification, in order to assess the performance of individual technologists. For this purpose, data processing engine 30 is used to detect image problems using any of a number of image processing modules.

Some examples of problems or image defects that can be detected by image processing include:

1) the diagnosis-relevant anatomy is clipped or partially clipped in the image, which influences image diagnosis. As discussed below, technology for detecting this defect is disclosed in previously mentioned U.S. Ser. No. 11/834,222.

2) the patient moved during image capture which caused image blur. As discussed below, technology for detecting this defect is disclosed in previously mentioned U.S. Ser. No. 11/834,304.

3) unexpected artifacts appear in the image, obscuring or partially obscuring a region of interest and possibly preventing diagnosis. Technology for detecting this defect is disclosed in an article by Beibei Cheng et al, “A Novel Computational Intelligence-based Approach for Medical Image Artifacts Detection”—Proceedings of 2010 International Conference on Artificial Intelligence and Pattern Recognition, 2010: 113-20, ISBN: 978.1-60651-015-5, the entire contents of which hereby are incorporated by reference into this application.

4) the image was captured at an inappropriate exposure, which may result in noise, speckle, or other undesired problems in image display quality. Technology for detecting speckle is disclosed in previously mentioned U.S. Ser. No. 11/959,805. Technology for detecting over or under exposure is disclosed in an article by Richard Van Metter et al, “Applying a proposed definition for receptor dose to digital projection images”—Medical Imaging 6142-45, February 2006, 1-19, the entire contents of which hereby are incorporated by reference into this application.

5) the image lacks the proper marker information (such as for laterality). Technology for detecting this defect is this closed in the previously mentioned article by Cheng et al, which those skilled in the art will understand can be used to detect missing markers as well as present defects.

6) the image has an unacceptable contrast-to-noise value in regions of interest. Technology for detecting this defect is disclosed in previously mentioned U.S. Ser. No. 12/486,230.

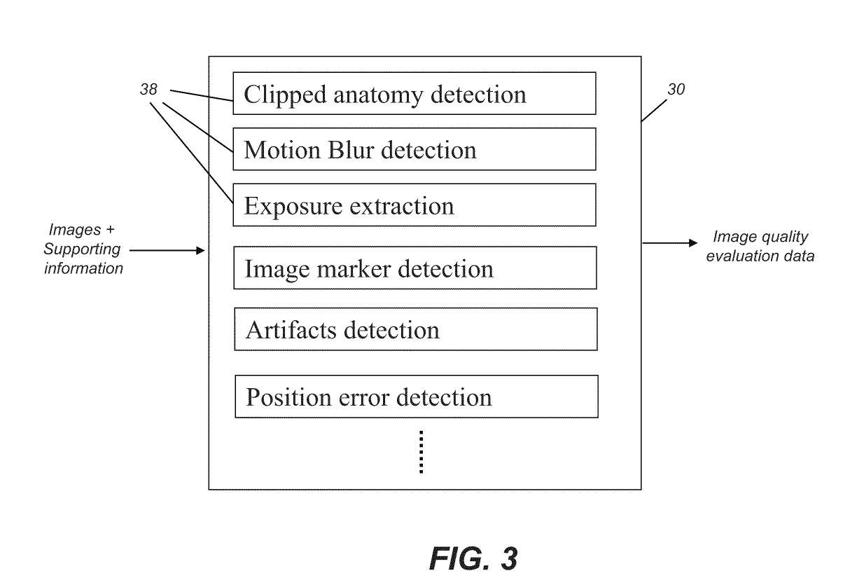

The block diagram of FIG. 3 shows functional components for programming instructions stored and executed by data processing engine 30 in one embodiment, designed for detecting image defects. In one embodiment of the invention the input of the data processing engine is digital diagnostic image data for one or more patients. In some instances, non-image support information about the image can be extracted from RIS database 24 or HIS database 26. The output of engine 30 is a set of image quality evaluation data extracted from the digital diagnostic images themselves.

In accordance with one embodiment of the invention, this image quality evaluation data can be a probability value indicating the severity of a specific image defect. In other embodiments, a set of features detected by the processing engine may be used to evaluate the severity of the defect.

As illustrated in FIG. 3, data processing engine 30 includes a number of specialized modules 38, such as programmed software routines, for detecting various types of image quality problems from patient images according to analysis of image data. The detection of various image defects can be accomplished using any of a number of suitable methods known to those skilled in the art, such as those previously discussed in this specification.

For detecting clipped anatomy in accordance with an embodiment of the invention, one suitable method is disclosed in previously mentioned U.S. Ser. No. 11/834,222. The image quality evaluation data for this defect can be expressed as a probability value by using an “apply trained classifier” step, in which a trained classifier algorithm is employed to recognize patterns of clipped or unclipped anatomy in the region of interest. In an “output probability confidence level” step, such a trained classifier can generate and output a probability value corresponding to its judgment of clipped or non-clipped status. The image quality evaluation data for artifacts, inappropriate exposure, speckle, missing markers and contrast-to-noise values, as previously discussed, also may be expressed as probability values using the technique just summarized.

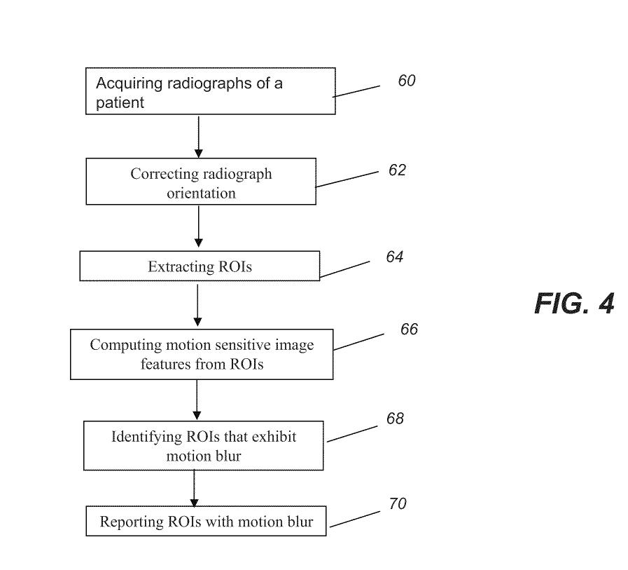

A suitable method for detecting motion blur in medical images is disclosed in previously mentioned U.S. Ser. No. 11/834,304. FIG. 4 shows an overall logic flow that can be used for the automated method, including an image acquisition step 60, a radiograph orientation correction step 62, a region location step 64, a computing motion step 66, an ROI identification step 68, and a reporting step 70.

In image acquisition step 60, the radiographic image is obtained in digital form. The image can be obtained directly from a digital image receiver, such as those used for CR or DR imaging. Optionally, the image can be obtained from a Picture Archiving and Communication System (PACS) or other networked source for radiographic images, or can be digitized from an existing film radiograph.

Proper positional orientation of the anatomical region of interest with respect to the digital receiver promotes obtaining accurate diagnostic assessment of the image and is desirable for further processing of image data. Continuing with the logic flow of FIG. 4, an orientation step 62 is carried out next to organize the image data so that it represents the image content with a given, predetermined arrangement. This step can be accomplished by using any of a number of methods known to those skilled in the art. One such automatic method is disclosed in commonly assigned U.S. Patent Application No. 2006/0110068, Ser. No. 10/993,055 filed on Nov. 19, 2004 by Luo et al. entitled “DETECTION AND CORRECTION METHOD FOR RADIOGRAPHY ORIENTATION”, now U.S. Pat. No. 7,519,207, the entire contents of which hereby are incorporated by reference into this application.

With the image oriented to the predetermined orientation, a region location step 64 is implemented. In this step, a template or set with one or more predefined regions of interest (ROI) is applied to the image to identify and extract areas of the image to be assessed for motion blur. According to at least one embodiment, the assignment of ROIs meets one requirement: that all ROIs are located within the anatomy region. Otherwise, the extracted features from the ROIs may not represent the characteristics of patient motion. The location of ROIs could be arbitrarily distributed in the anatomy region, or may be assigned based on given guidelines, generally associated with the anatomy or body part in the image.

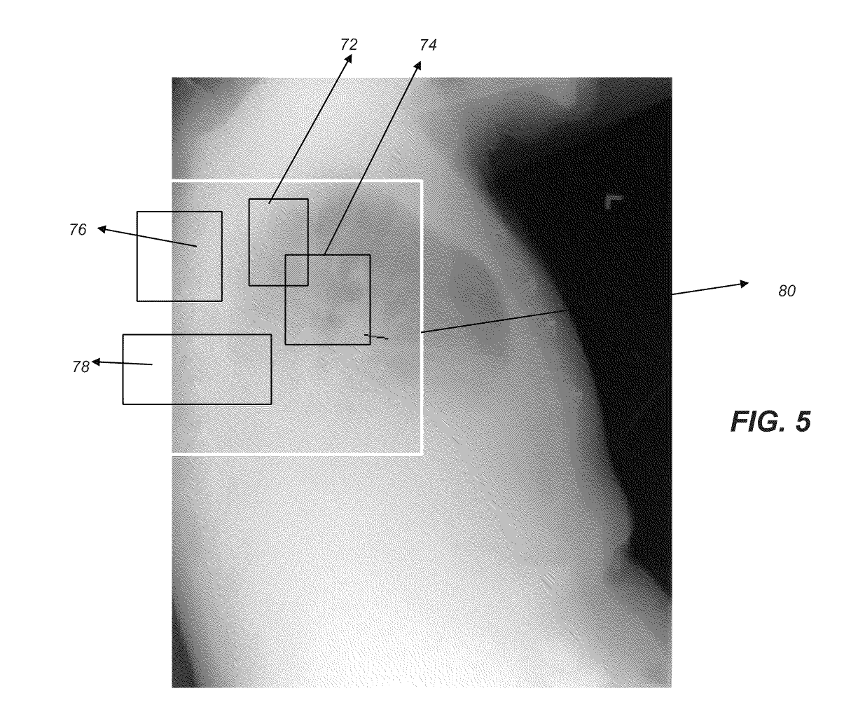

To show this by way of example, FIG. 5 illustrates locating ROIs in a conventional chest radiographic image taken with lateral projection view. In this example, a number of specific ROIs (72, 74, 76, 78), each shown as a rectangular area, are located around the lung region 80. For this type of image, this is where motion blur is likely to occur and where the radiologist's primary interest and interpretation are focused. In one embodiment, an ROI detection guideline is stored in memory in the system for each body part, in order to direct the search of ROIs for images of the associated body part. This forms a type of “template” that can then be stored and referenced for performing blur detection. Such a template is adaptable to fit the individual image. For example, a template element can be automatically scaled in order to adjust to patient size and can be rotated to align with the patient's orientation.

Another method for identifying and extracting ROIs is based on motion blur-sensitive features. This method initially assigns a set of pixels as “seeds” equally distributed throughout the anatomy region in the image. Then, an ROI grows outward from each seed by evaluating statistical values of the corresponding nearby features. The growth of an ROI continues as long as a predetermined requirement is met. In one embodiment, for example, ROI growth continues according to the change of statistics of the features relative to a predefined threshold. For example, the pixel value I(x,y) could be a feature. If the average pixel value of ROI I_{avg} is less than the predefined threshold Iₜₕ, the ROI will stop growing.

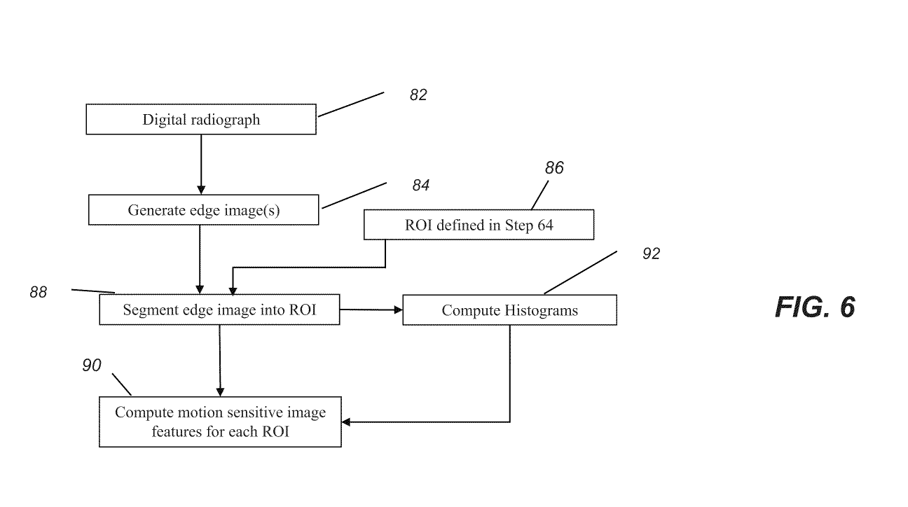

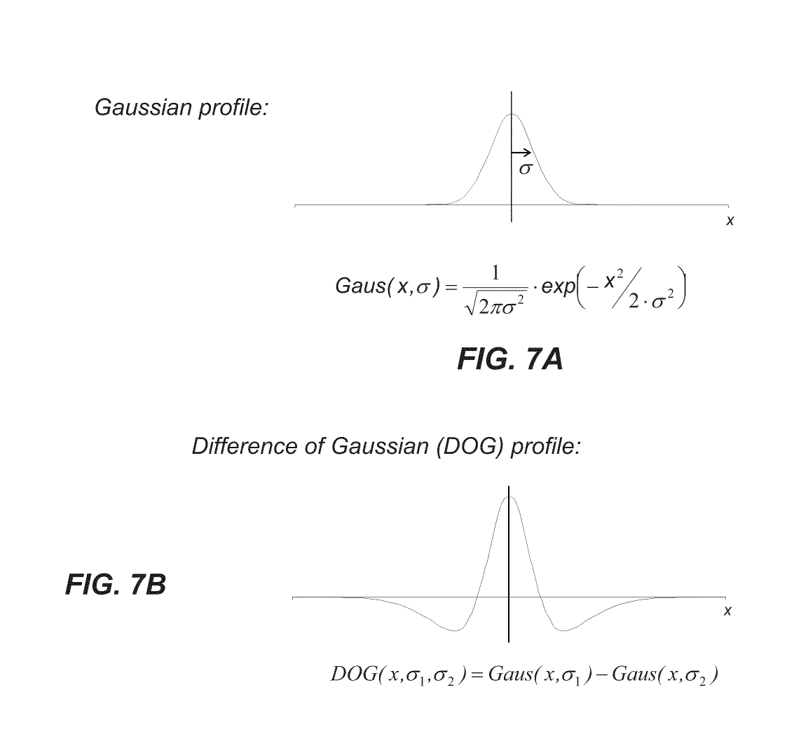

Referring back to the logic flow diagram of FIG. 4, computing motion step 66 is executed. A set of motion-sensitive features is calculated from one or more edge images for each ROI defined in step 64. FIG. 6 shows a logic flow diagram for calculating these features. After the digital radiograph is acquired in an obtain radiograph step 82, one or more edge images are calculated in an edge generation step 84. Two edge images are computed to accentuate the horizontal edges and the vertical edges independently. The horizontal edge image is calculated by convolving each row of pixels in the digital radiograph with a one-dimensional band-pass filter. The kernel of the band-pass filter may be taken to be the difference of two distinct Gaussian profiles, as shown in FIG. 7B. To reduce the level of noise introduced by the band-pass convolution, an optional smoothing filter may then be applied to the result. To minimize an adverse impact to the accentuated edges, a preferred method of smoothing is to convolve each column of pixels with a one-dimensional low-pass filter. The kernel of this low-pass filter would have a Gaussian profile, whose general shape is depicted in FIG. 7A. Mathematically, the resulting horizontal edge image E_{H} is described by the discrete convolution formula:

$${E}_{H} ( n , m ) = {\sum }_{j = 0}^{N} {\sum }_{k = 0}^{M} Gaus ( m - k , {σ}_{0}^{H} ) \cdot DOG ( n - j , {σ}_{1}^{H} , {σ}_{2}^{H} ) \cdot I ( j , k )$$

where I(n,m) represents the original N×M image pixel matrix and the one-dimensional functions Gaus(x,σ₀) and DOG(x,σ₁,σ₂,), superscripted ^{H} for horizontal values, are defined by the following formulas:

$$Gaus ( x , {σ}_{0} ) = \frac{1}{\sqrt{2 π {σ}_{0}^{2}}} \cdot exp ( - \frac{{x}^{2}}{2 \cdot {σ}_{0}^{2}} )$$

$$DOG ( x , {σ}_{1} , {σ}_{2} ) = Gaus ( x , {σ}_{1} ) - Gaus ( x , {σ}_{2} ) , {σ}_{1} < {σ}_{2}$$

Similarly, a vertical edge image E_{V} is constructed according to the discrete convolution formula:

$${E}_{V} ( n , m ) = {\sum }_{j = 0}^{N} {\sum }_{k = 0}^{M} Gaus ( n - j , {σ}_{0}^{V} ) \cdot DOG ( m - k , {σ}_{1}^{V} , {σ}_{2}^{V} ) \cdot I ( j , k )$$

In addition to these horizontal and vertical edge images, other edge images could be considered as well. For example, edge images oriented along the 45-degree diagonals, instead of along the primary axes, would be natural selections complementing the edge images E_{H} and E_{V} defined above. Edge images can be taken along any predetermined direction or axis.

Using the ROI defined in region location step 64 (FIG. 4) or from some other source, a segmentation step 88 (FIG. 6) segments edge images of interest to form separate ROIs. Then, in a computation step 90, a number of motion-sensitive features are calculated from each edge image generated in step 84 for each of the ROIs previously defined, shown as step 86. These features are later used to assess the possibility of motion or degree of motion within the given ROI. To simplify the description of features, the edge images are enumerated as Eⱼ, j=1, 2, . . . , J. N_{ROI} represents the number of pixels within the ROI; H^{j}_{ROI}(x) denotes the histogram of pixel values x from edge image Eⱼ restricted to the given ROI. The histogram is generated in a histogram step 92 as:

$${H}_{ROI}^{j} ( x ) = {\sum }_{( n , m ) ∈ ROI}^{ } {δ}_{Kr} ( {E}_{j} ( n , m ) - x ) ,$$

where δ_{Kr} denotes the Kronecker delta function:

$${δ}_{Kr} ( x ) = \{ \begin{matrix}0 , & x \neq 0 \\ 1 , & x = 0.\end{matrix}$$

Further, Edge_Min and Edge_Max denote, respectively, the minimum and maximum pixel values occurring within any of the computed edge images. The features, described in detail below, are enumerated as F^{q}_{ROI,Ej}, q=1, 2, . . . , 7, with the subscript (ROI,Eⱼ) indicating that the feature was computed from edge image Eⱼ within the given ROI.

The first two features F¹_{ROI,Ej} and F²_{ROI,Ej} provide a measure of the mean local variation:

$${F}_{ROI , {E}_{j}}^{1} = \sqrt{\frac{1}{{N}_{ROI}} \cdot {\sum }_{( n , m ) ∈ ROI}^{ } {( {E}_{j} ( n + 1 , m ) - {E}_{j} ( n , m ) )}^{2}}$$

$${F}_{ROI , {E}_{j}}^{2} = \sqrt{\frac{1}{{N}_{ROI}} \cdot {\sum }_{( n , m ) ∈ ROI}^{ } {( {E}_{j} ( n , m + 1 ) - {E}_{j} ( n , m ) )}^{2}}$$

Values of these two features tend to decrease as the local pixel correlation increases, which is the case for an image that exhibits motion-blur.

The next two features F³_{ROI,Ej} and F⁴_{ROI,Ej} yield statistical measures of the variation of edge values within the ROI and are calculated using the edge histogram:

$${F}_{ROI , {E}_{j}}^{3} = \sqrt{\frac{1}{{N}_{ROI}} \cdot {\sum }_{c = Edge \_ Min}^{Edge \_ Max} {H}_{ROI}^{j} ( c ) \cdot {( c - \overline{{E}_{j}^{ROI}} )}^{2}}$$

$${F}_{ROI , {E}_{j}}^{4} = \frac{\sqrt{π}}{\sqrt{2} \cdot {N}_{ROI}} \cdot {\sum }_{c = Edge \_ Min}^{Edge \_ Max} {H}_{ROI}^{j} ( c ) \cdot \vert c - \overline{{E}_{j}^{ROI}} \vert$$

where E̅ⱼ̅^̅{̅R̅O̅I̅}̅ is the mean edge pixel value from within the region of interest:

$$\overline{{E}_{j}^{ROI}} = \frac{1}{{N}_{ROI}} \cdot {\sum }_{c = Edge \_ Min}^{Edge \_ Max} c \cdot {H}_{ROI}^{j} ( c ) .$$

Values of these two features F³_{ROI,Ej} and F⁴_{ROI,Ej} will be substantially identical in regions that exhibit significant motion blur where edge values are diminished and where noise fluctuations become more dominant. It is noted, when significantly strong edges appear in the ROI, the ratio of features F³_{ROI,Ej}/F⁴_{ROI,Ej} begins to increase sharply.

Two additional features are calculated from the tail of the edge histogram generated in step 330. Value ηⱼ^{ROI} represents an estimate of the noise level in edge image Eⱼ restricted to the given ROI. One method for estimating this noise level is outlined in commonly assigned U.S. Pat. No. 7,092,579, entitled “Calculating noise estimates of a digital image using gradient analysis” to Serrano et al, the entire contents of which hereby are incorporated by reference into this application.

Multiplying the noise level ηⱼ^{ROI} by a small scalar τ and using the product as a histogram threshold yields the following additional features:

$${F}_{ROI , {E}_{j}}^{5} = \frac{1}{{N}_{ROI}} \cdot {\sum }_{\vert c \vert > τ \cdot {η}_{j}^{ROI}} {H}_{ROI}^{j} ( c )$$

$${F}_{ROI , {E}_{j}}^{6} = \frac{1}{{F}_{ROI , {E}_{j}}^{5} \cdot {N}_{ROI}} \cdot {\sum }_{\vert c \vert > τ \cdot {η}_{j}^{ROI}} {H}_{ROI}^{j} ( c ) \cdot \vert c \vert$$

Feature value F⁵_{ROI,Ej} represents the relative area of pixels exceeding the given multiple, τ, above the base noise level while feature value F⁶_{ROI,Ej} provides an estimate of the edge strength or edge magnitude.

Another feature that can be used is related to the number of zero-crossings in the edge image and within the given ROI. A zero crossing occurs at certain pixel locations within an edge image whenever there is a strong edge transition at that location. To determine if a zero crossing occurs at a particular pixel location (n,m) in edge image Eⱼ, the pixel values in the edge image within a 3×3 window centered at the pixel location are examined. Within this window, the minimum and the maximum edge values can be computed, using:

$${Min}_{j} ( n , m ) = {MIN}_{{\vert n - {n}^{′} \vert \leq 1}_{\vert m - {m}^{′} \vert \leq 1}} ( {E}_{j} ( {n}^{′} , {m}^{′} ) )$$

$${Max}_{j} ( n , m ) = {MAX}_{{\vert n - {n}^{′} \vert \leq 1}_{\vert m - {m}^{′} \vert \leq 1}} ( {E}_{j} ( {n}^{′} , {m}^{′} ) )$$

It can be deduced that there is a zero crossing at pixel location (n,m) if the following conditions are met:

Minⱼ(n,m)≦−τ_{Z}

Maxⱼ(n,m)≧τ_{Z}

Maxⱼ(n,m)−Minⱼ(n,m)|≧δ_{Z}

Here, τ_{Z} is a small positive threshold, typically scaled to the amount of noise in the edge image, serving the purpose of eliminating those zero-crossings due to noise fluctuations. The other parameter, δ_{Z},≧2·τ_{Z}, is used to further limit the zero-crossings to only those that result from edges of significant magnitude. Letting Z^{#}_{ROI,Ej} denote the number of zero-crossings in edge image Eⱼ occurring in the given ROI, then:

$${F}_{ROI , {E}_{j}}^{7} = \frac{{Z}_{ROI , {E}_{j}}^{\#}}{{N}_{ROI}}$$

which represents the number of zero-crossings per unit area.

Features F¹_{ROI,Ej} through F⁷_{ROI,Ej} can be generated as described herein, combined and processed to form feature vectors or other suitable composite information, and then used to determine the relative likelihood of image blur in each identified ROI. Referring back to FIG. 4, identification of ROIs with motion blur is executed in an identification step 68 to examine the extracted image features in detail. With respect to the example chest radiograph image in FIG. 5, either of two patterns can be identified in the ROIs. A normal pattern indicates no motion blur, and an abnormal pattern has blur characteristics caused by motion of the patient.

Assessment of motion blur can be accomplished using a trained classifier, for example, which is trained to recognize patterns of motion blur. The input of the classifier can include a feature vector or a set of feature vectors computed from the ROIs, as just described. Based on these features, the classifier outputs a probability value that corresponds to its judgment of motion blur status of the ROI. The higher this probability value, the more likely that motion blur occurs in the ROI.

It is noted that embodiments of the present invention are not limited to generation and use of the above features or feature vectors. Suitable features that can be derived from the image or reference features can be used to promote distinguishing a normal region from a region that exhibits motion blur. This can include, for example, texture characteristics obtained from the region of interest. Other methods for detecting motion blur can use characteristics such as entropy from pixel intensity histograms taken for the ROI.

Because motion blur can vary significantly depending on the body part that is imaged, embodiments of the present invention may use trained classifiers specifically designed for each body part or for each view of a body part. For example, a motion blur detection classifier can be trained for lateral view chest radiographs and used for detecting patient motion solely in chest lateral view images. The use of an individual classifier trained in this way can help to prevent ambiguous results and can greatly improve the performance of the method.

Blur effects can be local, confined to only one or two ROIs, or can be more general or global, affecting the full diagnostic image. For an image having multiple ROIs that exhibit blur, the global probability should be derived in order to assess the entire image. In embodiments of the present invention, the global probability can be assessed using a probabilistic framework, such as a Bayesian decision rule, to combine probabilities from multiple ROIs.

Exposure extraction obtains the exposure level used for capturing each type of image. Other automated image analysis software detects image markers, speckle and a range of other image artifacts, or position errors. Still other types of specialized modules 38 could be used for detecting problems or obtaining information related to patient images such as tube placement for endo-tracheal (ET) tubes, feeding (FT) tubes, nasogastric tubes (NGT or NT) or other types of tubes. It can be appreciated that any number of appropriate methods for detection of imaging artifacts can be employed by data processing engine 30 within the scope of the present invention.

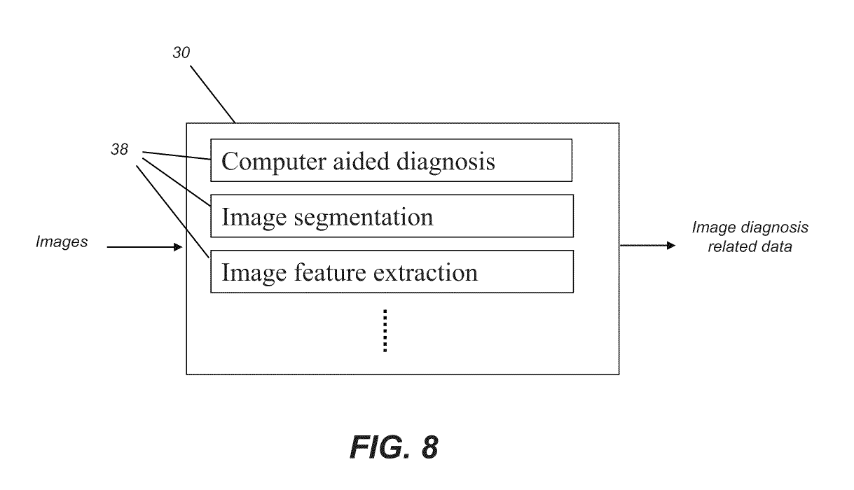

Alternately, diagnostic data can be obtained by data processing engine 30, as shown in the block diagram of FIG. 8. This type of function can be valuable to radiologists who are interested in finding images that are similar or relevant to a current study, such as to assist in diagnosis or training. In one embodiment of the present invention, data processing engine 30 performs image analysis that facilitates image retrieval. Data processing engine 30 can include specialized modules 38 for computer-aided detection or diagnosis, image segmentation, or feature extraction methods, as shown in FIG. 7. These image processing methods extract useful information or features for image analysis and comparison.

An advantage of the data processing engine is that, using ?only? information found within the stored digital diagnostic images themselves, it provides an automated way to filter images and efficiently discover images with quality problems. Based on the instructions provided by the user, the data processing engine will store in database 34 only those images compliant with the instructions, in other words the images with quality problems. In this way, the most informative images are discovered from the stored digital diagnostic images, thus providing an efficient way to quantify image quality at a medical imaging site.

### Data Mining Engine 32

Referring again to the system of FIG. 1, data mining engine 32, operating upon programmed instructions and using only information found within the stored digital diagnostic images themselves, extracts the information or discovers the hidden patterns or relationships in the data processed per instruction from query engine 36 and places its results in a data mining database 18. The information, pattern, or relationship provided by data mining engine 32 relates to what a user seeks, according to instructions provided from user instruction engine 40. This information may be previously unknown, and may have the potential of being very useful. In one embodiment of data mining, all possible queries from various users are collected and analyzed. The information that relates to the queries is then grouped. Based on the nature of the information, data mining engine 32 can extend the data attributes, create new attributes, and detect data correlated relationships.

Regarding image quality assurance, data mining engine 32 may be used to provide the means for supervisory and administrative staff to develop a better understanding of the image quality within the imaging department, identify existing problems or limitations, and search for possible solutions. According to one embodiment of the present invention, data mining engine 32 can generate a summary that supervisors or administrative staffs can use to systematically review the various performance profiles of technologists, radiologists, and clinicians, for example. It is recognized that technologist performance is a component of image quality assurance. Data mining engine 32 can be used to evaluate the performance of an individual technologist by generating a profile of defect images attributed to that technologist, including image dose trends and other image quality-related information. This information can then be further studied to pinpoint the skill strength or weakness of technologist practices, and help supervisors to plan an effective educational and training plan for the individual technologist if needed.

In another embodiment of the present invention, data mining engine 32 can also be used as an inference engine to discover or derive information in the data extracted from multiple data sources. For example, regarding image quality assurance, data processing engine 30 may detect an artifact in a chest image. However the artifact may not be located in the diagnosis interested region, which can be derived from examination report in RIS; in such event, the existing artifact would not affect image diagnosis. Thus, even with a detected artifact, an image may not be considered as having a defect, and its image quality may be still be considered suitable for image diagnosis. In this case, data mining engine 32 takes into account the support information from RIS or HIS databases 24 and 26 to determine the diagnosis interest regions in the image. Then, by combining the image-data-processed results with the diagnosis interest region, data mining engine 32 assesses the existence or severity of defects and outputs an evaluation score.

Data mining engine 32 can perform trend analysis and predict a possible problem using a domain knowledge-base related to the problem of interest. For example, data mining engine 32 can be designed to monitor the cumulative radiation exposure of patients, and to analyze radiation dose trends for an image site. If necessary, a signal from data mining engine 32 can promptly alert practitioners to a recurring high-dose problem and suggest appropriate solutions. In such a case, the output of data mining engine 32 would be an indicator or value indicative of the severity of the problem.

In another embodiment of the present invention, data mining engine 32 is employed to discover frequently occurring patterns, associations, and correlations among data elements provided from data source 20. For example, image quality relative to x-ray technique settings can be analyzed for stored images. As another example, the correlation between image motion blur and type of image can also be analyzed. It is known, for example, that this image artifact occurs primarily in examinations that require longer exposure times, such as chest lateral and lumbar spine exams. Motion blur can result from inability of the patient to hold still or may be due to involuntary factors, such as heart-beat and respiration. Data mining engine 32 can be used to study patterns and to analyze correlations between events and image quality such as these represent. Information obtained from this analysis can then be used to help improve training and use of equipment accordingly.

The inference method used in data mining engine 32 may include or interface to a Bayesian-type inference engine or other self-learning methods such as neural network, support vector machine, or other statistical or logical engine, application, or resource.

In the systems embodiment of FIG. 1, any new attributes, relationship or summary created during data mining, along with selected data from the processed database or support information from other data sources, are used to build data mining database 18 or other data storage entity. The creation, maintenance, and extension of data attributes and data relationships in data mining database 18 can be both hierarchical and multidimensional. These data are ultimately made available for searching, modeling, and other purposes by end users, in order to enhance the power and efficiency of end user analysis.

Non-image data elements, along with the image data, can potentially provide an assessment of image quality for the diagnostic images. In addition, some of the non-image data, when extracted and combined over a large number of images, can provide information on data trends that is helpful to the radiology staff, such as for developing a better understanding of its operations. For example, during image capture, the patient exposure dose is directly associated with the technique practices (e.g. kVp, mA, exposure time, mAs, and source-to-detector distance). For different exam types (i.e., body part and projection), different technique practices are used. Data mining engine 32 can be used to analyze the association between the exposure dose and technique practices of each exam type and, based on further data related to image quality for images of a particular type, can provide information on the optimal technique and guidance for image capture. This would not only provide information related to cumulative exposure and exposure-related trends during a period of time, thereby providing data that can help to efficiently reduce patient radiation, but can also provide information that can be directly used to improve image quality under various conditions. In a particular study, or series of images for a patient in the same session, a suitable exposure technique can be selected based on this data.

### Query Engine 36

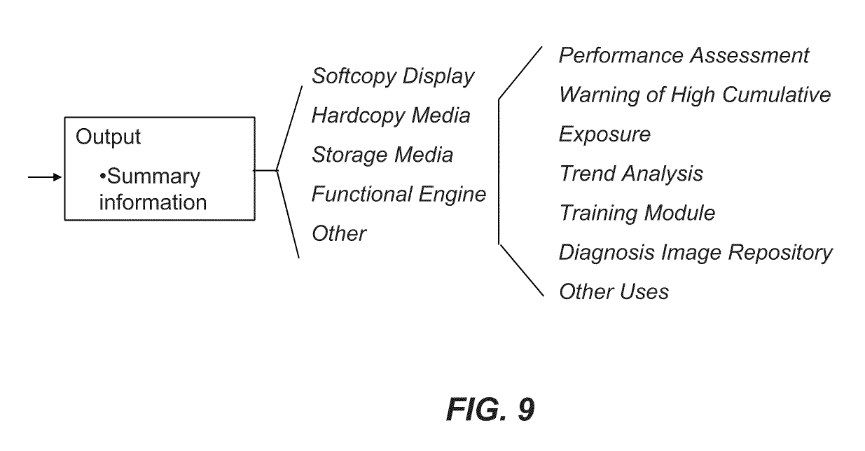

Still using the model system of FIG. 1, query engine 36 transforms information from user instruction engine 40 into SQL queries or other format queries to facilitate data processing or data mining. Alternately, query engine 36 may retrieve data from data mining database 18. It also generates summary information that may presented on a softcopy display, written to hardcopy, stored on storage media or used as input to another functional engine such as for image retrieval, and used for purposes that include performance assessment, alerting to some condition, trend analysis, training, and diagnosis. FIG. 9 is an illustration of some of the types and uses for output of query engine 36.

For example, a healthcare administrator may have a need to generate data on image quality, for benchmarking purposes, for all images collected over a six month period. The output in this case might be a table or chart presented to a display, sent to a printer, or written to a digital file; this chart can list body part, view position, and number of defective images, for example. In another application, a healthcare site may be very concerned about the exposure received by infants in the Neonatal Intensive Care Unit (NICU). The output in this case might be a warning sent to a monitoring display, a printer, or a file for infants who have reached a certain radiation exposure level. In another application, a healthcare administrator may wish to monitor technique practices over an extended time, even over a period of years. The output of query engine 36 could be directed to a digital file and stored, eventually to be used in a trend analysis. In another application, a healthcare site may wish to have a dedicated training station for technologists, radiologists, and clinicians. The output in this case might be a list or copy of images meeting a certain criteria that are placed on a digital storage device for viewing when studying a training module. In another case a radiologist may wish to identify images with certain CAD results. The output in this case might be a list of files or links to files, CAD results, or images written to a digital storage device.

### User Instruction Engine 40

Still using the model system of FIG. 1, user instruction engine 40 communicates to medical information system 10 the information desired and the form and type of output desired. User instruction engine 40 itself may use a graphical user interface, a digital file, or a voice sensitive system, for example. User instructions themselves can include directions for data processing engine 30, for data mining engine 32, and a listing of items to retrieve from data mining database 18. This may also include the type and format of output. User instructions may include ancillary instructions for use of the data, such as image retrieval or warning alert.

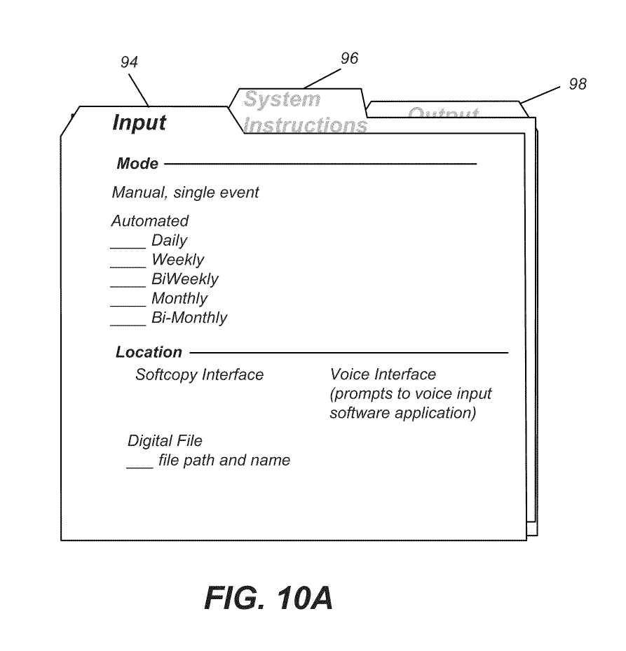

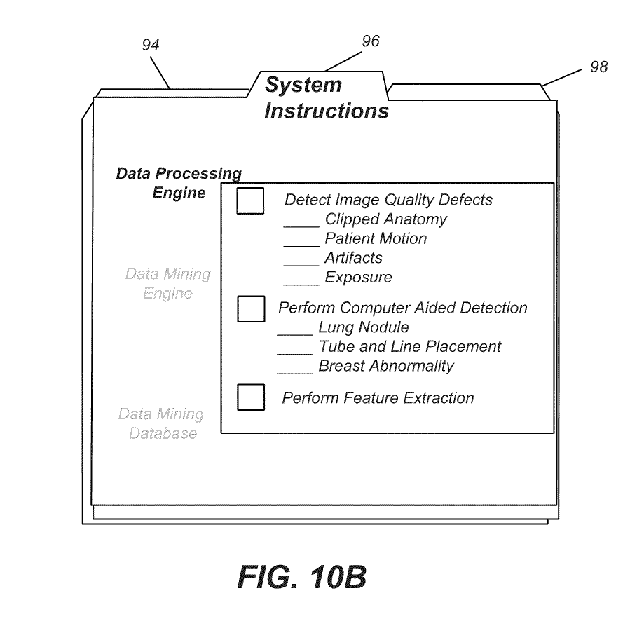

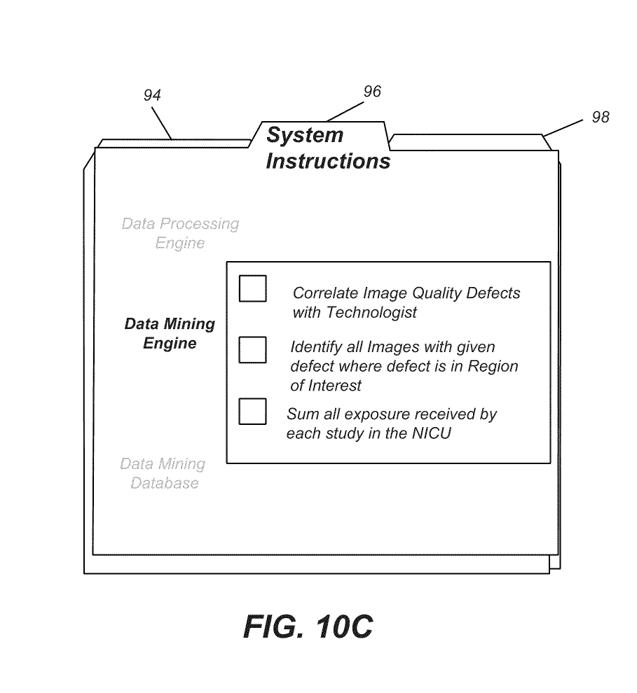

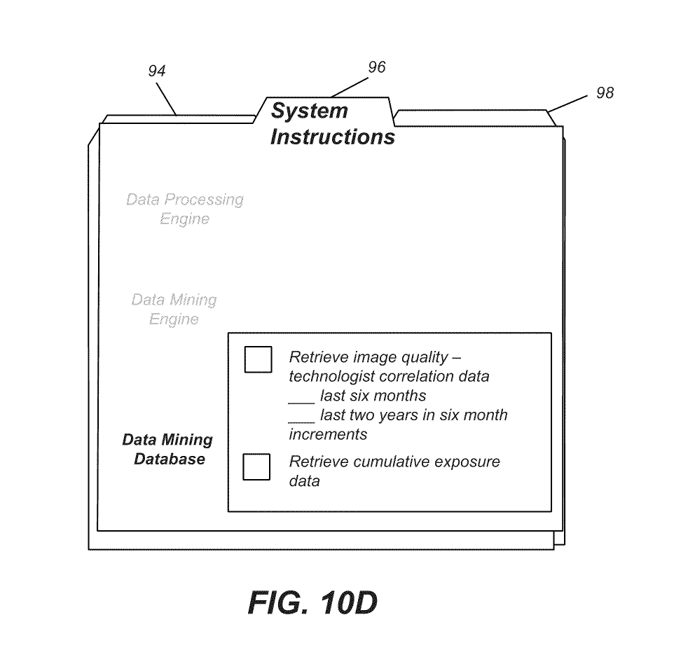

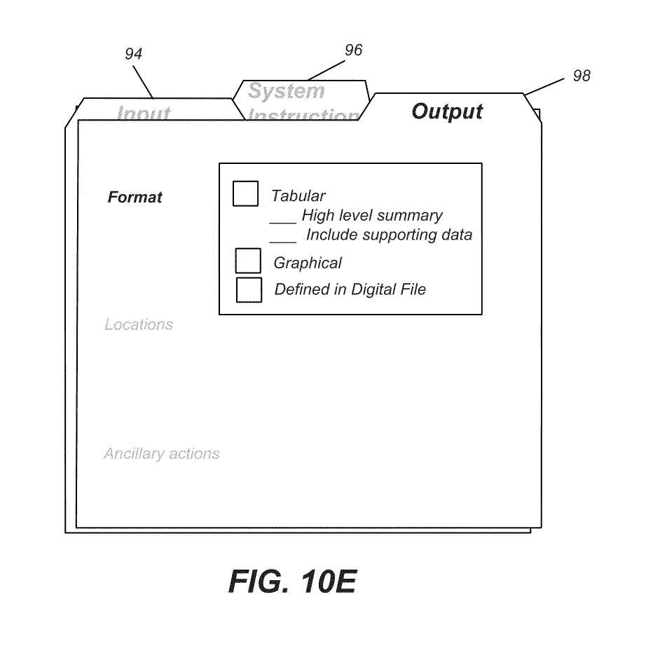

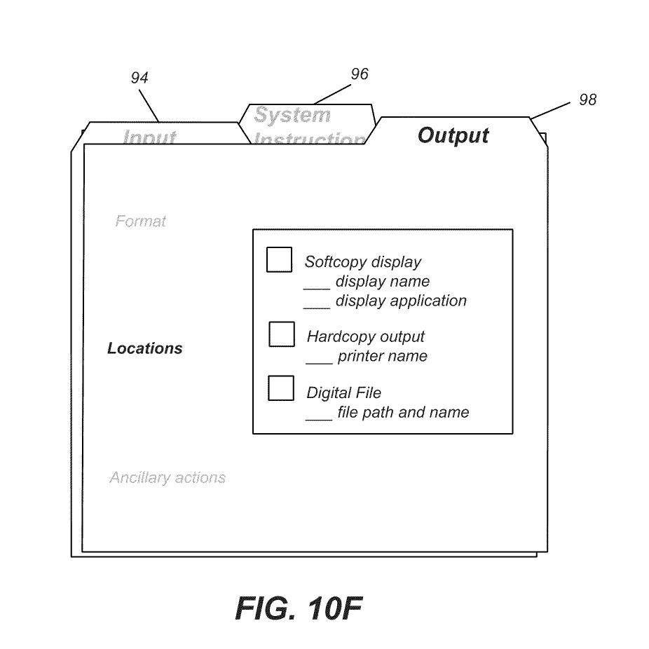

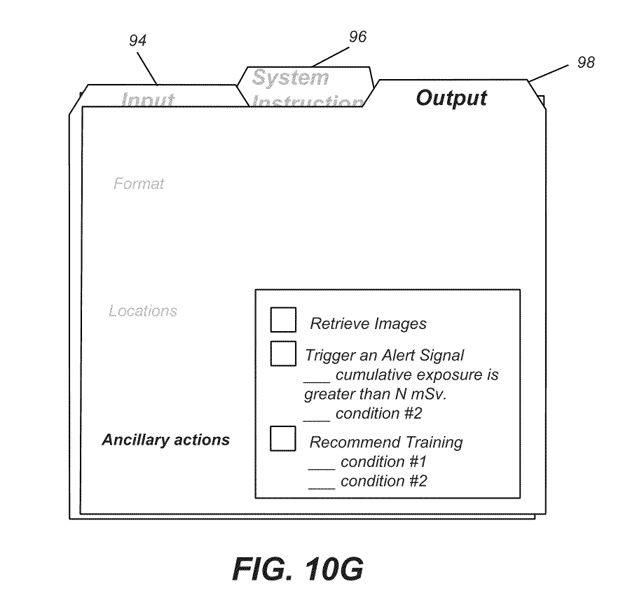

FIGS. 10A-10G illustrate the type of information that may be specified using a graphical user interface (GUI) of instruction engine 40, such as a display screen or touchscreen, for example. In the embodiment shown, the GUI has a tabular arrangement with an Input tab 94, a System Instructions tab 96, and an Output tab 98. Input tab 94 of FIG. 10A has entries for selecting a mode of operation, whether manually initiated or automated at some regular interval, and location of input data, such as a softcopy interface, digital file, or voice interface. for example. System Instructions tab 96 of FIGS. 10B, 10C, and 10D has entries for instructions relative to each of data processing engine 30, data mining engine 32, and data mining database 18. Instructions for data processing engine 30, for example, shown in FIG. 10B, utilize image analysis and Computer-Aided Detection (CAD) tools to obtain information from images of multiple patients for administrative or training functions. Instructions for data mining engine 32, shown in FIG. 10C, are then directed to correlation and summary information from images obtained. Instructions for data mining database 18, shown in FIG. 10D, retrieve stored data on image quality or imaging practices. Output tab 98 instructions, shown in FIGS. 10E, 10F, and 10G, are used to designate the format and locations for data that is obtained or to perform other actions, such as retrieving images or reporting results in various ways. Tabular or graphic output formats or file locations for example, may be selected for output formats. Ancillary actions may call other functional engines such as image retrieval for purposes such as diagnosis or training, triggering an alert, or training recommendations.

Unlike conventional data mining functions that are directed to obtaining information that is related to the condition, history, and treatment of an individual patient, medical information system 10 as shown in FIG. 1 and described herein is particularly well suited to the task of providing information that supports administration and delivery of health imaging services within a hospital or other medical facility. The apparatus and methods of the present invention read across multiple databases to obtain information from multiple patient records, where this information shows trends in how imaging services are provided. Image analysis functions are performed on selected images in order to obtain information that is relevant to the operation and effectiveness of a diagnostic imaging facility itself. Subsequent examples further illustrate use of medical information system 10 in particular embodiments.

### Example 1

Administrators at a hospital are concerned with the amount of radiation that is used for chest imaging, with a goal to improving results obtained and eliminating radiation above a maximum threshold value. Periodic monitoring of these values is desired. To provide this information from data source 20 (FIG. 1), a technician using the system of the present invention makes the following GUI entries to user instruction engine 40:

### Input Tab 94 Selections (FIG. 10A):

### Mode:

### Automated, BiWeekly

### Location:

Softcopy interface

### System Instructions Tab 96 Selections:

### Data Processing Engine (FIG. 10B)

Exposure defects

### Data Mining Engine (FIG. 10C)

Sum all exposure received by each study

### Data Mining Database: (FIG. 10D)

Retrieve cumulative exposure data

### Output Tab 98 Selections:

Format: Tabular, High level summary (FIG. 10E)
Locations: Hardcopy output, xyzz printer (FIG. 10F)
Ancillary actions: (none) (FIG. 10G)

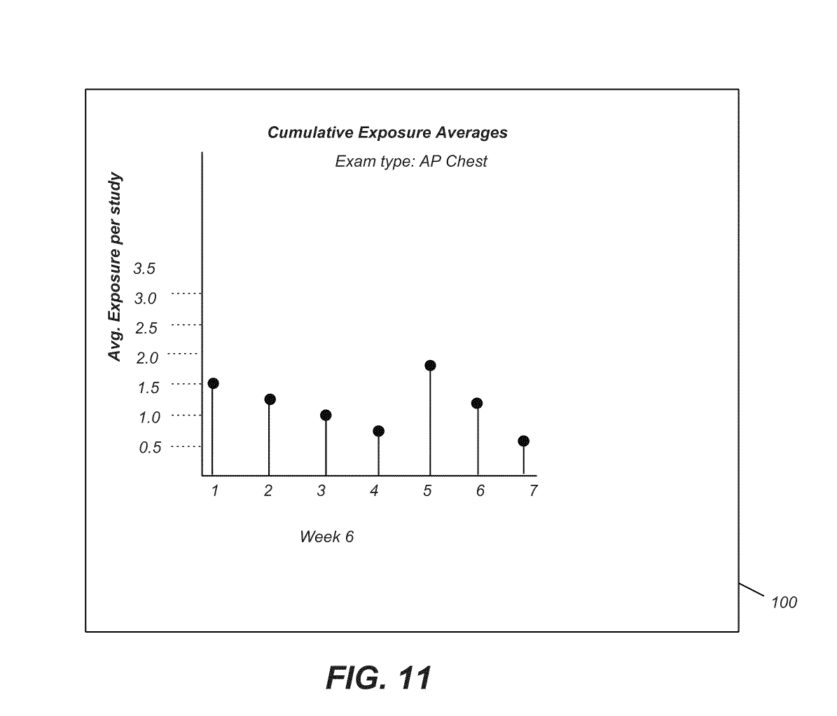

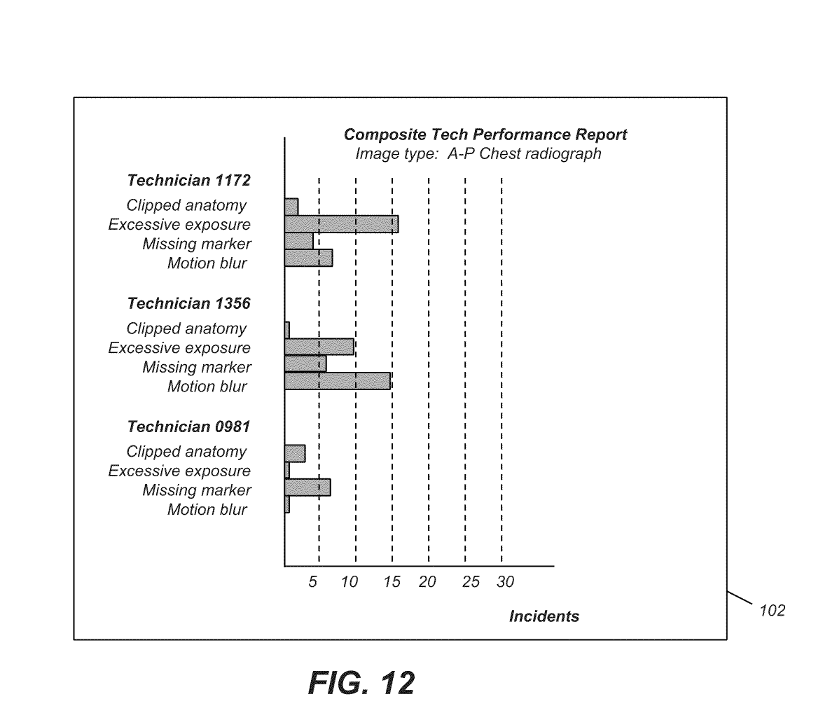

The technician then initiates the database search process, based on these entries. Data processing engine 30 of medical information system 10 (FIG. 1) then collects exposure data using utilities that calculate approximate exposure according to measured image data density. Methods for inferring exposure dose according to image data content are known to those skilled in the diagnostic imaging arts. FIG. 11 shows an example report 100 of cumulative exposure averages that is provided to the requesting user in one embodiment.

### Example 2

Due to excessive image quality defects reported by diagnosticians, training is recognized as a management priority for imaging personnel in a large medical facility. It is desirable to consider results from each imaging technician in order to help identify strengths and weaknesses and recommend additional training for individual technicians.

### Input Tab 94 Selections: (FIG. 10A):

### Mode:

### Automated, BiWeekly

### Location:

Softcopy interface

### System Instructions Tab 96 Selections:

### Data Processing Engine (FIG. 10B)

Clipped anatomy

### Patient Motion

### Artifacts

Exposure defects

### Data Mining Engine (FIG. 10C)

Correlate image quality defects with technologist

### Data Mining Database: (FIG. 10D)

Retrieve cumulative image quality data

### Output Tab 98 Selections: (FIG. 10E)

### Format: Graphical

Locations: Hardcopy output, xyzz printer (FIG. 10F)
Ancillary actions: (FIG. 10G)
Recommend training (condition #1, #2, etc.)

The technician then initiates the database search process, based on these entries. Data processing engine 30 of medical information system 10 (FIG. 1) then collects error data on image capture using utilities that detect problems such as clipped anatomy, motion blur, exposure problems, missing markers, tube placement, and similar problems in appropriately selected patient studies. FIG. 12 shows an example report 102 of technologist performance that is provided to the requesting user in one embodiment.

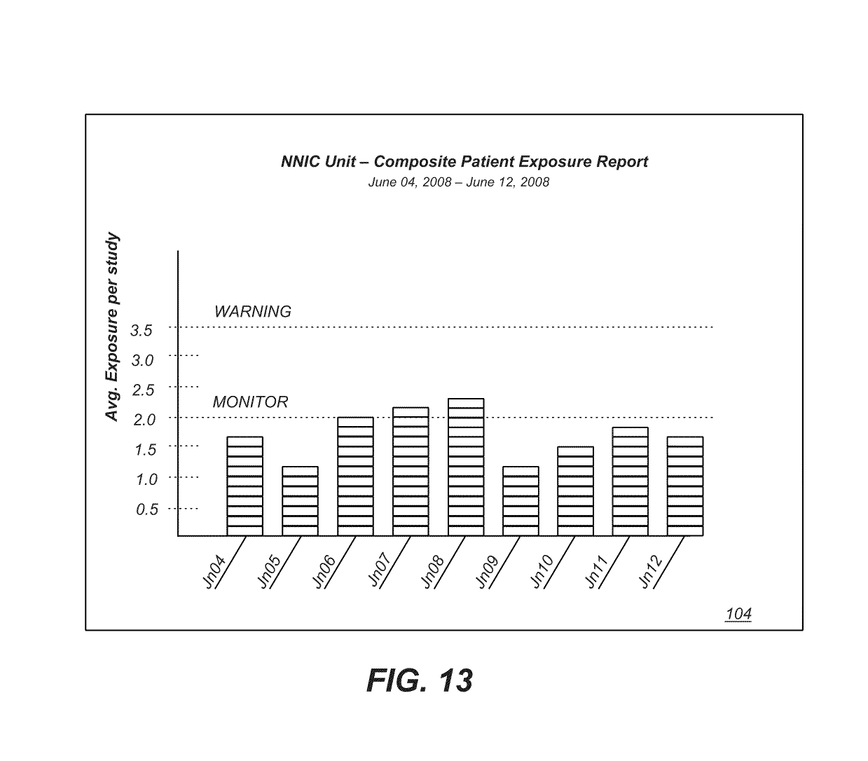

FIG. 13 shows another example output report 104 that gives data on patient exposure in a particular unit of the hospital. The displayed output in this example shows various levels of alert based on the data that is obtained and displayed.

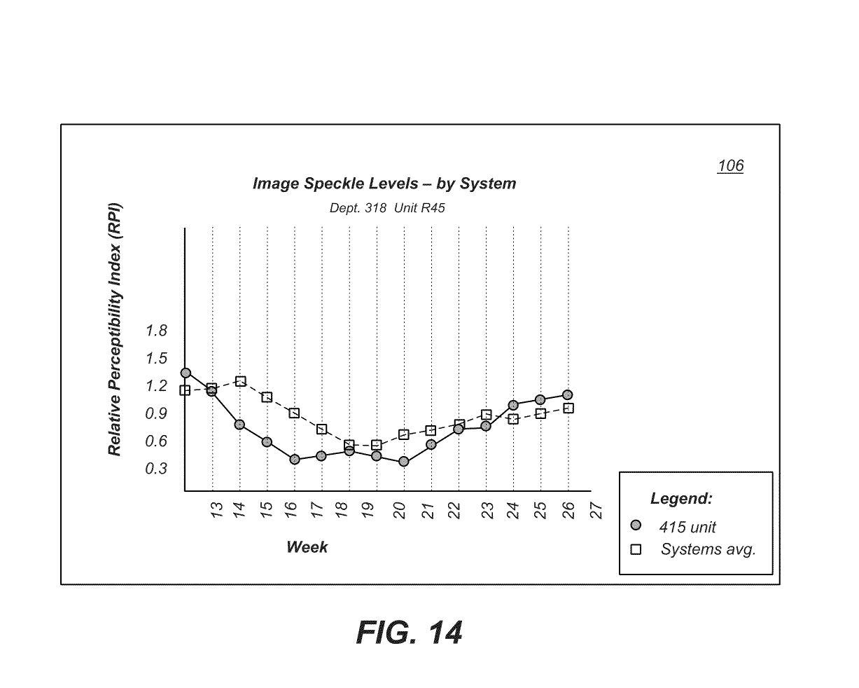

Methods of the present invention can also be used to monitor and track trends in equipment performance. FIG. 14 shows a graph in an output report 106 that is generated for displaying the perceptibility of image speckle per imaging system, with cumulative data displayed by the week. This type of information can be used to identify aging trends or to schedule maintenance or other service, for example. The system can also provide probability values or data related to image quality, including likelihood of proper detection of an image artifact, for example.

The invention has been described with reference to a subset of possible embodiments. However, it will be appreciated that variations and modifications can be effected by a person of ordinary skill in the art without departing from the scope of the invention. For example, various techniques could be employed for detecting image quality defects. GUI design can take any number of forms and the organization of elements for the user interface can be varied significantly from that shown in FIGS. 10A-10G in various embodiments.

Thus, what is provided is a system and method for obtaining information and knowledge relative to image quality obtained at an imaging site from image data that is stored in one or more medical image databases.

### PARTS LIST

10. Medical information system
18. Data mining database
20. Data source
22. PACS database
24. RIS database
26. HIS database
30. Data processing engine
32. Data mining engine
34. Processing database
36. Query engine
38. Module
40. User instruction engine
50. Source record
52. Patient identification field
54. Test field
58. Diagnosis field
60. Image acquisition step
62. Radiograph orientation correction step
64. Region location step
66. Computing motion step
68. ROI identification step
70. Reporting step
72., 74., 76., 78. Regions of interest
80. Lung region
82. Obtain radiograph step
84. Generate edge image step
86. Identify previous ROI step
88. Segment edge image step
90. Compute motion sensitive image features step
92. Compute histogram step
94. Input tab
96. System Instructions tab
98. Output tab
100., 102., 104., 106. Report

1. A system for discovering information related to diagnostic imaging performance at a medical imaging site, comprising:
at least one database of stored digital diagnostic images;
a user instruction interface for obtaining an operator request for information related to image quality of the stored digital diagnostic images;
a data processor in communication with the at least one database, the data processor being programmed with instructions to use only information found within the stored digital diagnostic images themselves:
(a) for retrieving digital diagnostic images for one or more patients from the at least one database according to the operator request from the user instruction interface,
(b) for analyzing the image quality of the retrieved digital diagnostic images as specified in the operator request, and
(c) for providing at least output information about the image quality analysis to a data mining engine; and
a data mining engine in communication with the data processor, the data mining engine being programmed with instructions to use only information found within the retrieved digital diagnostic images themselves: (1) for processing the output information that is obtained from the data processor; and (2) for providing information related to image quality and the diagnostic imaging performance at the medical imaging site, according to the output information.

2. The system of claim 1 wherein the instructions for retrieving digital diagnostic images specify one or more of patient medical condition, image capture system identifier, patient age, and type of diagnostic image.

3. The system of claim 1 wherein the provided information related to image quality comprises information related to one or more of a clipped anatomy defect, motion blur, over-exposure, under-exposure, image speckle, missing marker defect and unacceptable contrast-to-noise value.

4. The system of claim 3 wherein information provided by the data processor and the data mining engine relates to probability of an imaging artifact in the one or more retrieved patient diagnostic images.

5. The system of claim 1 wherein the instructions for retrieving one or more patient diagnostic images specify a particular imaging technologist.

6. The system of claim 1 wherein the instructions for retrieving one or more patient diagnostic images specify a particular imaging apparatus.

7. The system of claim 1 wherein the information provided by the data processor related to image quality comprises information on the severity of a detected problem.

8. The system of claim 1 wherein the data processor comprises one or more modules for analyzing the retrieved diagnostic images and outputting probability values to identify one or more of the group of imaging artifacts consisting of motion blur, over-exposure, under-exposure, clipped anatomy, missing marker, and image speckle.

9. The system of claim 1 wherein the information related to image quality from the data processor comprises information related to cumulative exposure and exposure-related trends during a period of time.

10. A method for discovering information related to diagnostic imaging performance at a medical imaging site from a database of stored digital diagnostic images, the method comprising using a computer to perform steps of:
obtaining user instructions for information related to image quality of the stored digital diagnostic images;
directing a query for the image quality information to a data processing engine;
using the data processing engine and only information found within the stored digital diagnostic images themselves, retrieving digital diagnostic images for one or more patients from the database according to the query;
analyzing the retrieved digital diagnostic images to provide an assessment of image quality thereof according to the query;
providing at least output information about the image quality assessment to a data mining engine;
using the data mining engine and only information found within the retrieved digital diagnostic images themselves, correlating the at least output information with one or more of a technician, an imaging apparatus, a patient condition, an image type, and a time interval; and
providing results of the correlating as output information related to image quality and the diagnostic imaging performance at the medical imaging site.

11. The method of claim 10 further comprising displaying the output information on a display monitor.

12. The method of claim 10 wherein the assessment of image quality comprises information about one or more of the group of imaging artifacts consisting of motion blur, over-exposure, under-exposure, clipped anatomy, missing marker, and image speckle.

13. The method of claim 12 wherein information provided by the data processing engine and the data mining engine relates to probability of an imaging artifact in the one or more retrieved patient diagnostic images.

14. The method of claim 10 wherein the output information further comprises warning information related to the assessment of image quality.

15. A method for obtaining information related to performance of a diagnostic imaging facility, the method comprising using a computer to perform steps of:
accessing a database of stored digital diagnostic images;
obtaining image quality criteria;
obtaining condition criteria that identify one or more of patient pathology, image capture apparatus, time interval, and technologist obtaining a digital diagnostic image found in the database;
using only information found within the stored digital diagnostic images themselves, retrieving one or more images for each of a plurality of patients from the database according to the condition criteria;
analyzing the one or more retrieved images according to the image quality criteria; and
reporting results of the analysis according to the image quality criteria as output information related to image quality and the diagnostic imaging performance at the diagnostic imaging facility.

16. The method of claim 15 wherein the step of obtaining image quality criteria comprises responding to instructions obtained from a user interface.

17. The method of claim 15 wherein the image quality criteria include one or more imaging artifacts taken from the group consisting of motion blur, over-exposure, under-exposure, clipped anatomy, missing marker, and image speckle.

18. The system of claim 17 wherein information provided by the retrieving and analyzing steps relates to probability of an imaging artifact in the one or more retrieved patient diagnostic images.

19. The method of claim 15 wherein reporting results further comprises providing information on the severity of an image artifact.
